(19) United States
(12) Patent Application Publication
(10) Pub. No.: US 2013/0053501 A1
(43) Pub. Date: Feb. 28, 2013

(54) COMPOSITE COMPOSITION FOR FRONT END MODULE CARRIER

(71) Applicants: Jong Hwal Kim, Daegu (KR); Min Ho Choi, Gwangmyeong (KR)

(72) Inventors: Jong Hwal Kim, Daegu (KR); Min Ho Choi, Gwangmyeong (KR)

(73) Assignees: DESCO CO., LTD., Chilgok-Gun (KR); HYUNDAI MOTOR COMPANY, Seoul (KR)

(21) Appl. No.: 13/293,332

(22) Filed: Nov. 10, 2011

(30) Foreign Application Priority Data
Aug. 22, 2011 (KR) 10-2011-0083704

(51) Int. Cl. C08K 7/14; C08L 23/12; C08L 77/02

(52) U.S. Cl. 524/514

(57) ABSTRACT

Disclosed is a lightweight reinforced plastic composite composition for a front-end module carrier, wherein glass fiber and carbon fiber are added as reinforcing agent to a resin mixture of an engineering plastic resin, such as polyamide, and a general-use plastic resin, such as polyalkylene. The disclosed composite composition is an ecofriendly composite material effective in reducing carbon dioxide emission and improving fuel efficiency in automobiles through reinforcement and weight reduction of the front-end module carrier.

### CROSS-REFERENCE TO RELATED APPLICATIONS

This application claims priority under 35 U.S.C. §119 to Korean Patent Application No. 10-2011-0083704, filed on Aug. 22, 2011, in the Korean Intellectual Property Office, the disclosure of which is incorporated herein by reference in its entirety.

### BACKGROUND

(a) Technical Field

The present invention relates to a lightweight reinforced plastic composite composition, wherein glass fiber and carbon fiber are added as reinforcing agents to a resin mixture of an engineering plastic resin, such as polyamide, and a general-use plastic resin, such as polyalkylene. The composite composition of the present invention is an ecofriendly composite material effective in reducing carbon dioxide emission and improving fuel efficiency in automobiles through reinforcement and weight reduction. The composite composition is particularly suitable for use in forming a front-end module carrier of an automobile.

(b) Background Art

Recently, the global auto industry has been making various efforts for the production of ecofriendly vehicles with high fuel efficiency and reduced carbon dioxide (CO₂) emissions. In particular, research has been focused on the manufacture of ecofriendly automobiles, such as electric cars, hybrid cars, hydrogen cars, solar cars, etc, which use alternative energy sources. However, replacement of automobiles using conventional internal combustion engines will be both time consuming and costly. Thus, in the short term, the auto industry is making efforts to develop ecofriendly automobiles with improved fuel efficiency and reduced carbon dioxide (CO₂) emissions by using lightweight materials which thereby reduce the weight of the automobiles.

In the past, all the automobile parts were assembled on the automobile assembly line. Currently, modular parts are widely used to facilitate assembly. In particular, several parts are pre-assembled by contractors as modules, and the final assembly is performed using these modules on the automobile assembly line. This saves both time and costs. Examples of such modules include, but are not limited to, the door module, the head lining module, the cockpit module, and the front-end module carrier.

The front-end module carrier includes the front-end parts of a vehicle, which typically includes a carrier, an intercooler, a horn, a cooling fan, head lamps, and the like. These constituent parts are mounted together to form the front-end module carrier. The existing front-end module carriers can be classified into a plastic type, which is formed only of plastic, and a hybrid type, into which a steel sheet is inserted. Although the plastic-type front-end module carrier is light and easily injection-moldable, its rigidity and durability are insufficient, particularly when compared to the hybrid-type front-end module carrier. For example, the plastic-type front-end module carrier is weak against collision and may be deformed when attached to heavy objects. On the other hand, while the hybrid-type front-end module carrier has better rigidity and durability when compared to the plastic-type front-end module carrier, it is heavy because of the weight of the steel sheet. For these reasons, the plastic-type front-end module carrier is mainly used for small cars, while the hybrid-type front-end module carrier is generally used for mid- to large-sized cars.

Korean Patent No. 1,013,858 describes a thermoplastic plastic composite for a hybrid-type front-end module carrier. The thermoplastic plastic composite mixture comprises a resin, selected from cyclic butylene terephthalate and caprolactam, and one or more catalyst selected from butyltin chloride dihydroxide, titanate and distannoxane, coated on one or more fiber mat, selected from glass fiber and carbon fiber. The thermoplastic plastic composite is used instead of the steel sheet in order to reduce weight, and thus reduce carbon dioxide emission and improve fuel efficiency.

Korean Patent No. 921052 describes a polyamide resin composition for an automobile fuel tank baffle with improved impact resistance and alcohol resistance. A mixture of a male- or glycidyl-based reactive compatibilizer, an olefin-based impact modifier, an imide-based hydrolysis stabilizer, an amine- or phosphite-based antioxidant, a phenol-based heat stabilizer and an olefin-based lubricant is added to a resin mixture of a polyamide resin and a high-density polyethylene resin.

Japanese Patent Application Publication No. S63-0305148 describes a glass fiber-reinforced polyamide composition wherein glass fiber is added to a mixture comprising polyamide, modified polyolefin and a propylene homopolymer or copolymer.

However, there is still a need for further improvements in such compositions. For example, a reinforced resin composition comprising a polyamide resin (which is known to have superior heat resistance, chemical resistance, etc.) as base resin and glass fiber as reinforcing agent suffers from decreased dimensional stability due to moisture absorption. Further, such materials are still too heavy and/or lacking in strength.

### SUMMARY

The present invention provides a novel reinforced plastic composite composition, that is both strong and lightweight. The present composition is particularly suitable for use in forming a front-end module carrier of an automobile. However, it is understood that use of the composition is not limited as such, but rather, the composition could also be used to form other automobile parts where, for example, a strong and lightweight material is beneficial.

In one general aspect, the present invention provides a lightweight reinforced plastic composite resin composition for a front-end module carrier, including: one or more engineering plastic resins selected from the group consisting of polyamide, polyalkylene terephthalate and polyketone; one or more general-use plastic resins selected from the group consisting of acrylonitrile butadiene styrene, polystyrene, polyvinyl chloride and polyalkylene; glass fiber; and carbon fiber.

The above and other aspects and features of the present invention will be described infra.

### DETAILED DESCRIPTION

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments.

On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

The present invention provides a reinforced plastic composite resin composition suitable for a front-end module carrier, which includes an engineering plastic resin, a general-use plastic resin, glass fiber and carbon fiber. Such compositions, wherein both glass fiber and carbon fiber are added to a resin mixture of an engineering plastic resin and a general-use plastic resin, provide a number of benefits including reduced weight and enhanced physical properties.

In an embodiment of the present invention, a mixture of an engineering plastic resin and a general-use plastic resin is used as base resin, and glass fiber and carbon fiber are used together as a reinforcing agent. In particular, the general-use plastic resin is added to the engineering plastic resin and the combination is used as the base resin to decrease weight and prevent or minimize a reduction of dimensional stability caused by moisture absorption. The present compositions further include both glass fiber and carbon fiber as the reinforcing agent, thereby further decreasing weight and improving strength.

In an embodiment of the present invention, the engineering plastic resin may be one or more selected from the group consisting of polyamide (which can include, for example, polyamide 6, polyamide 66, polyamide 11, polyamide 12, polyamide 46, polyamide 610, etc.), polyalkylene terephthalate (which can include, for example, polyethylene terephthalate (PET), polybutylene terephthalate (PBT), etc.), and polyketone. In exemplary embodiments, the engineering plastic resin may be provided in an amount of about 10-70 wt % based on the total weight of the composite resin composition. In various embodiments, the composite resin composition can include any amount of engineering plastic resin ranging from at least about 10 wt % (e.g. at least about 15 wt %, about 20 wt %, about 25 wt %, about 30 wt %, etc.) up to about 70 wt % (e.g., up to about 65 wt %, about 60 wt %, about 55 wt %, about 50 wt %, etc.).

In an embodiment of the present invention, the general-use plastic resin may be one or more selected from the group consisting of acrylonitrile butadiene styrene (ABS), polystyrene, polyvinyl chloride, and polyalkylene, such as polyethylene, polypropylene, polybutylene, etc. In an exemplary embodiment, polyalkylene, which is a general-use plastic resin with superior heat resistance and impact resistance, is used. In embodiments wherein polypropylene, which is light and has superior heat resistance, is used, both an improvement in impact resistance and a reduction in weight can be provided at the same time. In exemplary embodiments, the general-use plastic resin may be provided in an amount of about 5-70 wt % based on the total weight of the composite resin composition. In various embodiments, the composite resin composition can include any amount of general-use plastic resin ranging from at least about 5 wt % (e.g. at least about 10 wt %, about 15 wt %, about 20 wt %, about 25 wt %, etc.) up to about 70 wt % (e.g., up to about 65 wt %, about 60 wt %, about 55 wt %, about 50 wt %, etc.).

In various embodiments of the present invention, about 5-30 wt % of glass fiber and about 5-30 wt % of carbon fiber are used together as the reinforcing agent, wherein the wt % is based on the total weight of the composite resin composition. In various embodiments, the composite resin composition can include any amount of glass fiber or carbon fiber ranging from at least about 5 wt % (e.g., at least about 8 wt %, about 10 wt %, about 12 wt %, about 14 wt %, etc.) up to about 30 wt % (e.g., up to about 28 wt %, about 26 wt %, about 24 wt %, about 22 wt %, about 20 wt %, etc.). In an exemplary embodiment, the composite resin composition includes about 10-20 wt % glass fiber and 10-20 wt % carbon fiber.

Carbon fiber is known to have a strength of 10-20 g/d, a specific gravity of 1.5-2.1, as well as excellent heat resistance, impact resistance and chemical resistance. Further, carbon fiber is lighter than aluminum metal, and has superior elasticity and strength when compared with iron metal.

In accordance with various embodiments of the present invention, commonly used additives can be included, such as heat stabilizers (Cu/KI) for preventing aging that may occur during hot-temperature processing for preparation of the reinforced plastic composite, antioxidants (e.g., tris(2,4-di-tert-butylphenyl) phosphite) for suppressing autoxidation by oxygen, coupling agents (e.g., aminopropyltriethoxysilane) for improving binding ability, and the like. The various additives and amounts used can be readily determined by one skilled in the art based on desired properties. In certain embodiments, the processing temperature may be about 220-280° C. It has been found that if the temperature is too low (e.g., below about 220° C.), the resin may be partly melted, leading to difficulty in the processing. On the other hand, if the temperature is too high (e.g., above about 280° C.), it may be difficult to prepare the reinforced plastic because of a change in the properties of polyamide that generally occurs at such temperatures.

### EXAMPLES

The examples and experiments will now be described. The following examples and experiments are for illustrative purposes only and not intended to limit the scope of this invention.

### Examples 1-4 and Comparative Examples 1-2

Reinforced plastic composite compositions for a front-end module carrier were prepared with compositions described in Table 1. Various physical properties of the prepared compositions were measured, and these properties are set forth in Table 2.

TABLE 1

| | | | | | | Comparative | |
|---|---|---|---|---|---|---|---|
| | | | | | | Examples | |
| | | Examples (wt %) | | | | (wt %) | |
| | | 1 | 2 | 3 | 4 | 1 | 2 |
| Resin | Polyamide 6 | 64 | 59 | 54 | 49 | 69 | 69 |
| | Polypropylene | 5 | 10 | 15 | 20 | 0 | 0 |
| Reinforcing | Glass fiber | 10 | 10 | 10 | 10 | 10 | 30 |
| agent | Carbon fiber | 20 | 20 | 20 | 20 | 20 | 0 |
| Additives | Heat stabilizer | 0.6 | 0.6 | 0.6 | 0.6 | 0.6 | 0.6 |
| | Antioxidant | 0.2 | 0.2 | 0.2 | 0.2 | 0.2 | 0.2 |
| | Coupling agent | 0.2 | 0.2 | 0.2 | 0.2 | 0.2 | 0.2 |

Heat stabilizer: Cu/KI

TABLE 2

| | | | | | Comparative | |
|---|---|---|---|---|---|---|
| | Examples | | | | Examples | |
| | 1 | 2 | 3 | 4 | 1 | 2 |
| Tensile strength | 2,080 | 1,970 | 1,890 | 1,820 | 2,120 | 1,800 |
| (kgf/cm²) | | | | | | |
| Impact strength | 13 | 13 | 14 | 14 | 10 | 10 |
| (kgf · cm/cm) | | | | | | |
| Flexural strength | 2,550 | 2,480 | 2,300 | 2,260 | 2,700 | 2,500 |
| (kgf/cm²) | | | | | | |
| Flexural elasticity | 128,000 | 121,000 | 119,000 | 112,000 | 133,000 | 85,000 |
| (kgf/cm²) | | | | | | |
| Specific gravity | 1.24 | 1.22 | 1.20 | 1.19 | 1.26 | 1.36 |

As seen in Table 2, the compositions of Examples 1-4, which incorporate 10 wt % of glass fiber and 20 wt % of carbon fiber as the reinforcing agent, demonstrated improvement in tensile strength, flexural strength and flexural elasticity as compared to the composition of Comparative Example 2 which included 30 wt % of glass fiber as the reinforcing agent. Also, the compositions of Examples 1-4, which include both the engineering plastic resin and the general-use plastic resin, demonstrated considerably improved impact strength as compared to the compositions of Comparative Examples 1-2 which did not include the general-use plastic resin. Further, it was demonstrated that the compositions of Examples 1-4 have relatively lower specific gravity as compared to the compositions of Comparative Examples 1-2, which means that the compositions are lighter in weight.

As demonstrated in the above results, the reinforced plastic composite composition the present invention, which comprises the engineering plastic resin and the general-use plastic resin as the base resin, and also comprises glass fiber and carbon fiber as the reinforcing agent, has improved tensile strength, impact strength, flexural strength and flexural elasticity as well as a decrease in weight.

Further, when used to manufacture automobile parts, the reinforced plastic composite composition of the present invention can achieve a significant reduction in weight when compared to conventional compositions, such as about 10% weight reduction. For example, when the present composition is used to manufacture the front-end module of the YF model (2009 Hyundai Car Model YF), a reduction in weight of about 0.5 kg can be achieved. Further, the present composition showed comparable or improved performance in hood latch strength required for the front-end module when compared to the currently used materials.

The present invention has been described in detail with reference to specific embodiments thereof. However, it will be appreciated by those skilled in the art that various changes and modifications may be made in these embodiments without departing from the principles and spirit of the invention, the scope of which is defined in the appended claims and their equivalents.

What is claimed is:

1. A lightweight reinforced plastic composite resin composition for a front-end module carrier, comprising:
one or more engineering plastic resins selected from the group consisting of polyamide, polyalkylene terephthalate and polyketone;
one or more general-use plastic resins selected from the group consisting of acrylonitrile butadiene styrene, polystyrene, polyvinyl chloride and polyalkylene;
glass fiber; and
carbon fiber.

2. The lightweight reinforced plastic composite resin composition for a front-end module carrier according to claim 1, which comprises:
about 10-70 wt % of the engineering plastic resin;
about 5-70 wt % of the general-use plastic resin;
about 5-30 wt % of glass fiber; and
about 5-30 wt % of carbon fiber.

3. The lightweight reinforced plastic composite resin composition for a front-end module carrier according to claim 1, wherein the engineering plastic resin is one or more polyamide selected from the group consisting of polyamide 6, polyamide 66, polyamide 11, polyamide 12, polyamide 46 and polyamide 610.

4. The lightweight reinforced plastic composite resin composition for a front-end module carrier according to claim 1, wherein the general-use plastic resin is one or more polyalkylene selected from the group consisting of polyethylene, polypropylene and polybutylene.

5. A front-end module carrier comprising one or more front-end parts fabricated from the lightweight reinforced plastic composite resin composition according to claim 1.
